(19) United States
(12) Patent Application Publication
(10) Pub. No.: US 2009/0313158 A1
(43) Pub. Date: Dec. 17, 2009

(54) ONLINE CLOSING SYSTEM AND METHOD

(76) Inventor: David Del Monte, New York, NY (US)

Correspondence Address: OSTROLENK FABER GERB & SOFFEN, 1180 AVENUE OF THE AMERICAS, NEW YORK, NY, 100368403, US

(21) Appl. No.: 12/484,706

(22) Filed: Jun. 15, 2009

Related U.S. Application Data
(60) Provisional application No. 61/131,972, filed on Jun. 13, 2008.

(51) Int. Cl. G06Q 40/00; G06F 17/30

(52) U.S. Cl. 705/35; 707/104.1; 707/1; 707/E17.044

(57) ABSTRACT

A system and method for processor-enabled interactive real estate deals, the system comprising storing, on one or more processor readable media that are operatively coupled to one or more processors. The database includes electronic deal information including information representing at least one real estate transaction, buyer information representing at least one buyer associated real estate transaction(s), seller information representing seller(s) respectively associated with real estate transaction(s), broker information including information representing buyer broker(s) and seller broker(s), deal point information representing deal point(s) associated with the real estate transaction(s), management company information representing management company/companies and deal point information representing at least one deal point associated with the real estate transaction(s). At least one contract is provided as a function of selection(s) of the deal information, the buyer information, the seller information, the broker information, the broker information, the deal point information, the management company information, the deal point information and the contract template information for a real estate transaction.

### CROSS-REFERENCE TO RELATED APPLICATION

This application is based on and claims priority to U.S. Provisional Application Ser. No. 61/131,972, filed on Jun. 13, 2008 and entitled ONLINE CLOSING SYSTEM AND METHOD, the entire contents of which are hereby incorporated by reference.

### BACKGROUND

1. Field of the Invention

The present invention relates, generally, to communication and, more particularly, to an interactive on-line real estate transaction monitoring and communication.

2. Description of the Related Art

In the prior art, individual parties associated with real estate transactions, particularly residential real estate, operate in disjointed and independent ways. Each party performs data entry related to real estate transactions using individual computing devices or the like, which results in error-prone, inefficient redundancies, and which cumulatively require tremendous amounts of time and human resources.

### SUMMARY

Accordingly, it is an object of the teachings herein to provide real estate brokers, transactional attorneys, and other parties associated with real estate transactions with an interactive and accessible tool that adds accuracy and efficiency to facilitate the purchase and sale of real estate between a buyer and seller.

Broker and attorney registration information and preloaded building and management company data add efficiency and accuracy to the systems and methods described herein. Accordingly, multiple re-typing of same data by buyer/seller real estate brokers and buyer/seller attorneys is eliminated, such as when preparing contract, deal sheet, and so on documents by making the online system for all the involved parties.

Accordingly and in an embodiment, a system and method for processor-enabled interactive real estate deals, the system comprising storing, on one or more processor readable media that are operatively coupled to one or more processors. The database includes electronic deal information including information representing at least one real estate transaction, buyer information representing at least one buyer associated real estate transaction(s), seller information representing seller(s) respectively associated with real estate transaction(s), broker information including information representing buyer broker(s) and seller broker(s), deal point information representing deal point(s) associated with the real estate transaction(s), management company information representing management company/companies and deal point information representing at least one deal point associated with the real estate transaction(s). At least one contract is provided as a function of selection(s) of the deal information, the buyer information, the seller information, the broker information, the broker information, the deal point information, the management company information, the deal point information and the contract template information for a real estate transaction.

Other benefits include improved user satisfaction, reduced time to learn, and extended number of involved users by providing modern Internet-based application with attractive look-and-feel, perfect usability, and professionally polished output documents.

Further, the number of man-hours for every day usage and maintenance costs are reduced and/or eliminated by a flexible and smart application, which uses the standardized and component-based technologies.

Other features and advantages of the present invention will become apparent from the following description of the invention that refers to the accompanying drawings.

### BRIEF DESCRIPTION OF THE DRAWING(S)

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware arrangement in an embodiment and referred to generally as online closing system 100;

FIG. 2 illustrates the functional elements of user workstation and/or information processor in accordance with an embodiment;

FIG. 3 illustrates a plurality of user workstations operated by respective parties to a real estate transaction and in communication with an information processor in accordance with an embodiment;

FIG. 4 is a block diagram illustrating an example functional overview provided by information processor in accordance with an embodiment;

FIG. 5 is a block diagram illustrating administrative options provided by information processor in an embodiment;

FIG. 6 illustrates an example display screen for a user to register with information processor;

FIG. 6A is example display screen for broker and attorney data entry in accordance with an embodiment;

FIG. 6B is an example display screen for uploading data in accordance with an embodiment;

FIG. 7 illustrates an example display screen for viewing and selecting deals associated with a given user in accordance with an embodiment;

FIG. 7A illustrates an example display screen that is available for users to search for particular deals in an embodiment;

FIG. 8 is an example display screen for locating or editing information regarding a property, in accordance with an embodiment;

FIG. 9 shows an example data entry data screen for users to add/edit information related to buyers' and sellers' brokers in accordance with an embodiment;

FIG. 10 shows an example data entry data screen for users to add/edit information related to buyers of properties, in accordance with an embodiment;

FIG. 10A shows an example data entry data screen for users to add/edit information related to buyers' attorneys, in accordance with an embodiment;

FIG. 11 shows an example data entry data screen for users to add/edit information related to sellers of properties, in accordance with an embodiment;

FIG. 12 shows an example data entry data screen for users to add/edit information related to management companies and/or closing companies, in accordance with an embodiment;

FIG. 13 shows an example data entry data screen for users to add/edit information related to deal points in connection with a particular deal in an embodiment;

FIG. 14 shows an example data entry data screen for users to add/edit information related to legal points in connection with a particular deal;

FIG. 15 shows an example data entry data screen for users to add/edit information related to a deal sheet in connection with a particular deal;

FIG. 16 illustrates an example contract provided in accordance with an embodiment; and

FIG. 17 is a flowchart showing example steps associated with providing a contract in accordance an embodiment.

### DESCRIPTION OF THE EMBODIMENTS

In accordance with an embodiment, an interactive tool is provided for one or more of real estate brokers, transactional attorneys, buyers, sellers, management companies, and their respective agents, to improve accuracy and efficiency from a mere verbal agreement between a buyer and seller to completion of a formal, written contract and closing on real estate property. Preferably, various forms of data, including property data, broker-related information, attorney-related data, building and management company data and legal data in one or more databases are securely provided to a plurality of parties over a communication network, such as the Internet. Information is preferably entered and/or submitted once, thereby precluding parties, such as real estate brokers, attorneys and their agents to a real estate transaction from having to re-type or enter related to a single transaction in connection, for example, with a contract, deal sheet or the like. Accordingly, the number of steps and the amount of time required in a typical, prior art real estate transaction are reduced as a function of an Internet web-based application that provides an intuitive, graphical look-and-feel, user convenience, and that outputs professional-looking and polished documents.

In addition and in an embodiment, an interactive and on-line contract preparation and facilitation application is provided to streamline the agreement process between buyers and sellers. Contracts are preferably prepared, reviewed and/or modified between real estate attorneys, brokers or corresponding agents using the systems and methods herein. Accordingly, improved preparation and delivery of real estate contracts from and to respective parties associated with real estate transactions is facilitated. Real estate brokers, transactional attorneys and other parties associated with real estate transactions are provided with an interactive Internet-based tool that improves accuracy and efficiency for buyers and sellers to purchase and sell real properties. Among other benefits, the number of hours typically required for preparing, reviewing and modifying real estate agreements between various parties is drastically reduced, as well as the amount of maintenance costs associated therewith via a flexible and intuitive application, which implements suitably standardized and component-based technologies.

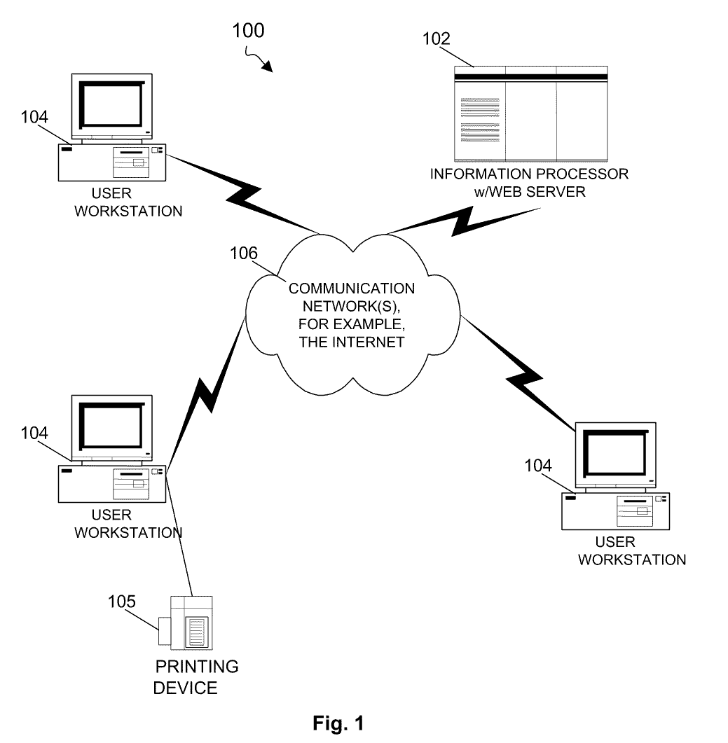

Referring now to the drawings, in which like reference numerals refer to like elements, FIG. 1 shows an example hardware arrangement in an embodiment and referred to generally as online closing system 100 or “OCS.” In the embodiment shown in FIG. 1, online closing system 100 comprises at least one information processor 102 (configured to operate as an Internet web server and database file server) adapted to access communication network 106 and communicate with user workstations 104. Printing device 105 is operable to print finished, executable agreements and may formatted as any known printing device, including laser printer, ink jet printer, impact printer (e.g., dot matrix) or the like. User workstations 104 and information processor(s) 102 preferably communicate via the known communications protocol, Transmission Control Protocol/Internet Protocol “TCP/IP.” In this way, content can be transmitted to and from the devices 102 and 104, and commands can be executed to enable the various functions described herein.

As used herein, the term, “module” refers, generally, to one or more discrete components that contribute to the effectiveness of the teachings herein. Modules can operate or, alternatively, depend upon one or more other modules in order to function.

Information processors 102 and user workstation 104 are any devices that are capable of sending and receiving data across communication network 106, e.g., mainframe computers, mini computers, personal computers, laptop computers, a personal digital assistants (PDA) and Internet access devices such as Web TV. In addition, information processors 102 and user workstation 104 may be equipped with a web browser, such as MICROSOFT INTERNET EXPLORER, NETSCAPE NAVIGATOR, MOZILLA FIRREFOX or the like. Thus, as envisioned herein, information processor 102 and/or user workstation 104 are devices that can communicate over a network and can be operated anywhere, including, for example, moving vehicles.

The nature of the teachings herein is such that one skilled in the art of writing computer executable code (i.e., software) can implement the described functions using one or more of a combination of popular computer programming languages and developing environments including, but not limited to C, C++, Visual Basic, JAVA, PHP, HTML, XML, ACTIVE SERVER PAGES, JAVA server pages, servlets, AJAX, and/or a plurality web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. One or more data formatting and/or normalization routines may be provided that manage data received from one or a plurality of sources. In another example, data are received that are provided in a particular format (e.g., MICROSOFT EXCEL), and programming routines are executed that convert the data to another formatted (e.g., ASCII comma-delimited text or XML).

It is contemplated herein that any suitable operating system can be used on user workstations 104 and information processor 102, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, WINDOWS VISTA, MAC OS, UNIX, LINUX, PALM OS, POCKET PC or any other suitable operating system. Of course, one skilled in the art will recognize that other software applications are available in accordance with the teachings herein, including, for example, via JAVA, JAVA Script, Action Script, Swish, or the like.

Moreover, a plurality of data file types is envisioned herein. For example, various suitable multi-media file types are supported, including (but not limited to) JPEG, BMP, GIF, TIFF, MPEG, AVI, SWF, RAW or the like (as known to those skilled in the art).

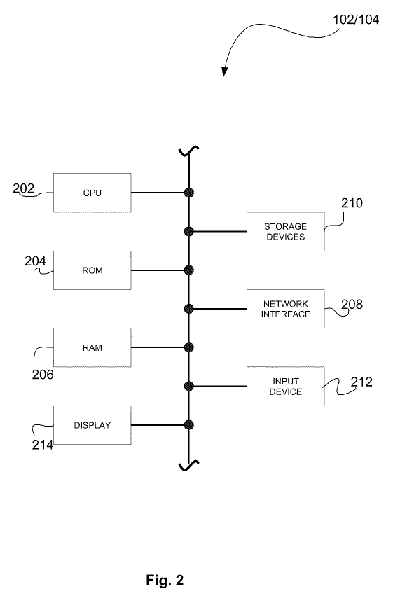

FIG. 2 illustrates the functional elements of user workstation 104 and/or information processor 102 and that include one or more central processing units (CPU) 202 used to execute software code and control the operation of computing devices 102/104, read-only memory (ROM) 204, random access memory (RAM) 206, one or more network interfaces 208 to transmit and receive data to and from other computing devices across a communication network, storage devices 210 such as a hard disk drive, floppy disk drive, tape drive, CD ROM or DVD for storing program code, databases and application data, one or more input devices 212 such as a keyboard, mouse, track ball, microphone and the like, and a display 214.

The various components of information processor 102 and/or user workstation 104 need not be physically contained within the same chassis or even located in a single location. For example, storage device 210 may be located at a site which is remote from the remaining elements of information processor 102 or user workstation 104, and may even be connected to CPU 202 across communication network 106 via network interface 208. Information processor 102 includes a memory equipped with sufficient storage to provide the necessary databases, forums, and other community services as well as acting as a web server for communicating hypertext markup language (HTML), FLASH, Action Script, Java, Active Server Pages, Active-X control and other programs on user workstation 104. Information processors 102 are arranged with components, for example, those shown in FIG. 2, suitable for the expected operating environment of information processor 102. The CPU(s) 202, network interface(s) 208 and memory and storage devices are selected to ensure that capacities are arranged to accommodate expected demand.

In a preferred embodiment, a system and method are provided that enable interactive exchange of information between users, such as via an Internet web site provided on information processor 102. The web site may prompt users to enter, review and/or modify information related to real estate and/or residential real estate transactions. Users preferably review data provided by other users, to provide a cohesive, interactive network of users associated with, for example, a real estate transaction.

In one embodiment, the teachings herein are applicable for residential real estate transactions and access to database(s), display screen(s) and the like, and are provided for brokers, attorneys and their respective agents. In alternative embodiments, commercial real estate transactions are supported. Further, buyers and sellers, as well, access data via data entry display screens, reports or the like, including by providing electronic and binding signatures on, for example, real estate contracts. The use of electronic and binding signatures may provided in any of the various contexts described herein.

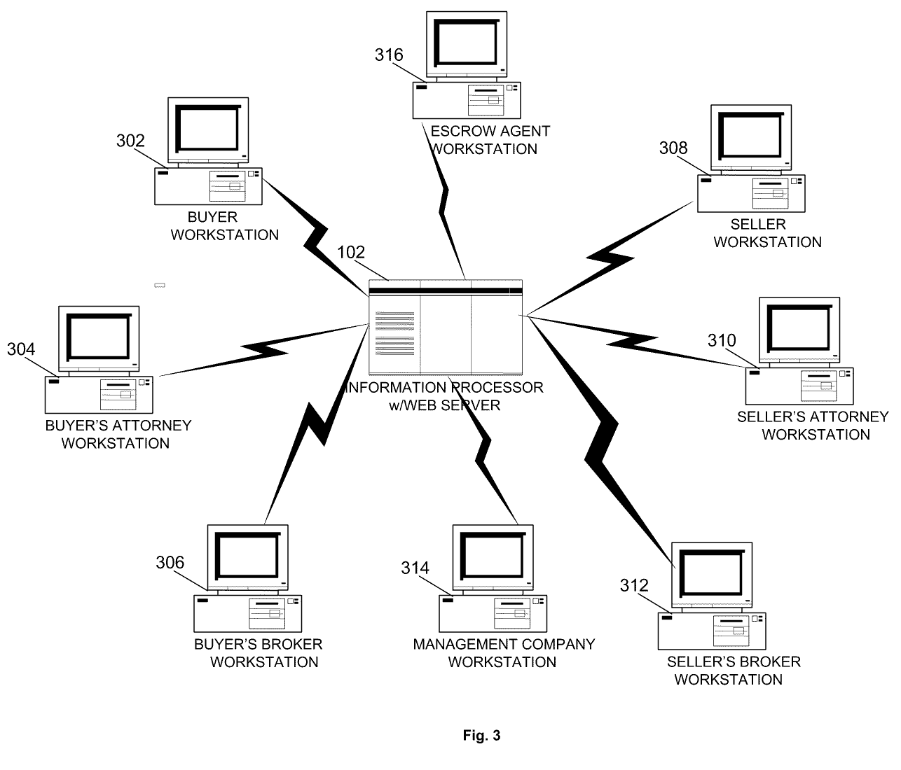

FIG. 3 illustrates a plurality of user workstations 104 operated by respective parties to a real estate transaction that send/receive data to and from information processor 102 in accordance with an embodiment. It is envisioned herein that any combination of user workstations 104 shown in FIG. 3 may view, send and/or receive data from/to information processor 102, and that the inclusion of the respective parties in FIG. 3 is not meant to limit the invention to the precise arrangement thereof. As shown in FIG. 3, buyer workstation 302, buyer's attorney workstation 304 and buyer's broker workstation 306 interact with information processor 102 and preferably represent the interests of the buyer. Moreover, seller workstation 308, seller's attorney workstation 310 and seller's broker workstation 312 interact with information processor 102 and preferably represent the interests of the seller. Other affiliated parties of the buyer and seller, including assistants of the buyer's and seller's respective attorneys and brokers are similarly envisioned as electronically interacting with information processor 102, such as to review, send and receive information in connection with a real estate transaction between a buyer and seller. Other user workstations 104 operated by parties to a real estate transaction and illustrated in FIG. 3 include management company workstation 314 and escrow agent workstation 316. Of course, one skilled in the art will recognize that other parties and corresponding workstations may be employed in various embodiments in accordance with the teachings herein.

In a preferred embodiment, users are authorized to access data and data entry display screens provided via information processor 102 by a proprietor thereof. In one embodiment, rules are defined that, when met, authorize users to access information processor 102. Referred to herein, generally as “invited users,” a user, such as a broker or/attorney may be invited to register to access data and data entry display screens provided via information processor 102 by a proprietor, administrator user and/or registered user thereof. Registered users are preferably provided with or otherwise provide a user name and password that enable secured access to information processor 102. Each registered user is preferably authorized for particular access to data and/or data entry display screens provided via information processor 102, with additional or fewer rights being granted or revoked over time. For example, buyer's and seller's brokers access display screens on information processor 102 to view, enter and/or modify information pertaining to a real estate transaction, referred to herein, generally as a “deal.” For example, brokers access contact information relating to the involved parties, as well as data regarding property, a property management company, terms of a contractual deal, legal points of a contract, or the like. Brokers can initiate property purchase and sale deal sheets and/or contracts. Further, attorneys preferably access information processor 102 and verify, reject and/or alter deal information, for example, entered by brokers. For example, a buyer's attorney modifies terms of a real estate agreement before the seller's attorney opened the deal. In this example, editing of the terms is restricted to only the seller's attorney. Other embodiments are envisioned, however, in which restriction to access is tailored in connection with individual agreements. The attorneys preferably work on deal output, accept the deal sheet and mark a deal as completed, when appropriate. Thus and in one or more embodiments, registered parties, such as brokers and/or attorneys, initiate a deal sheet and/or contract.

In addition to brokers and attorneys, administrators, such as managers associated with a proprietor of information processor 102 may access information processor 102 to perform many if not all of the previously described actions, as well as to view deals, the status of respective deals, data output reports or the like. Administrators preferably also manage other users' accounts, import users from external data files, such as in a comma-delimited text file, an MS EXCEL file or the like, and configure data to be stored and/or accessed via information processor 102.

As used herein, the term deal sheet refers, generally, to terms of one or more contracts. The term, legal points, refers, generally to a real estate purchase and sale closing time and location. The term, deal points, refers generally to information about a deal, and may include information such as unit details, commission, included items, and included real property data.

In accordance with a preferred embodiment, data entry redundancy by a plurality of parties is eliminated via centralized and routine operations performed in connection with one or more databases accessed by information processor 102. In an embodiment, a deal sheet containing basic agreement terms is generated and shared between brokers, and delivered to a seller's attorney. Eventually, much information from a deal sheet flows into the contract, which is then transmitted to the buyer's attorney and their respective clients for signature.

Information processor 102 preferably functions as an Internet web serve, and provides automated routines for seller/buyer brokers and attorneys. Data that rarely change is otherwise relatively static, such as that regard residential properties, brokers and attorneys contact information is stored and accessible for various parties, thereby precluding a need to re-enter the data by multiple parties. In an embodiment, associated parties are notified, such as via e-mail, instant message, short message or the like, about changing transaction state. For example, parties are notified when data are updated by a buyer's or seller's broker. Moreover, output documents are substantially automatically generated and formatted, for example, as ADOBE PDF documents.

In various embodiments, data are obtained from various sources and in various formats. For example, static data (e.g., property information, broker/attorney information or the like) are obtained in one or more formats (e.g., MS-EXCEL spreadsheets, XML data files or the like) and, when imported into one or more databases accessible by information processor 102, are searchable, such as by one or more AJAX requests, as known in the art.

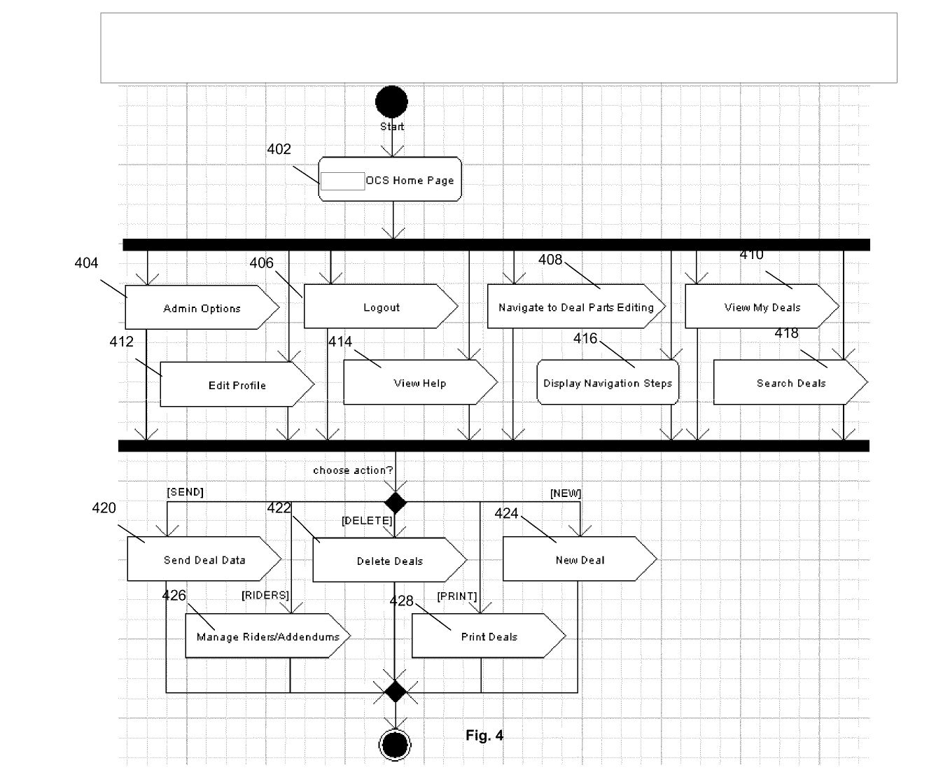

FIG. 4 is a block diagram illustrating an example functional overview provided by information processor 102 for users who connect thereto using web-based services, in accordance with an embodiment. At the top of FIG. 4 is home page 402, from which other functionality is provided via information processor 102. For example, administrative options, 404, logout 406, deal parts editing 408, my deals 410, profile 412, help 414, navigation steps 416, and search deals 418 options are respectively available for various users of information processor 102. Once one or more of those options are selected, additional actions are available, including send deal data 420, delete deal data 422, create new deal 424, manage riders and/or addendums 426, and print deals 428, as appropriate in a given context.

Preferably, a user submits authorization information (e.g., user name and password) to login to gain secure access to information processor 102. The user's credentials evaluated and the user may be authenticated/and authorized for access to data entry display screens and data, as appropriate. Preferably, a successful login process redirects the user to OCS home page 402.

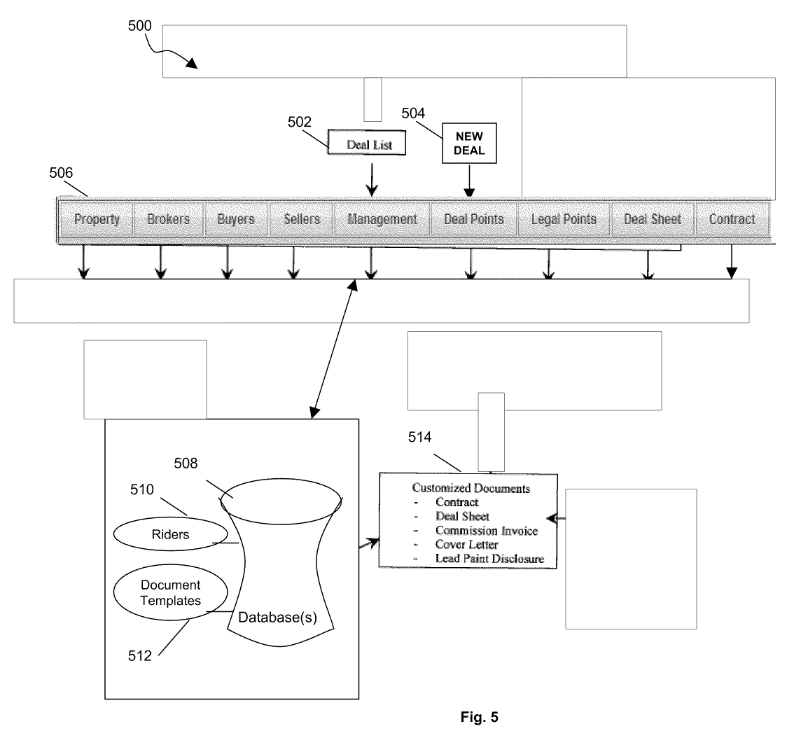

FIG. 5 is a block diagram illustrating administrative options 500 provided by information processor 102, particularly in connection with contractual deal points. Deal list 502 and new deal 504 preferably enable users to select options for an existing deal or add a new deal. For example, options 506, enable users to select information related to a deal's property, brokers, buyers, sellers, management company, deal points, legal points, deal sheet and/or contract. Information processor 102 preferably provides options 506 at least in part as a function of database(s) 508. Rider information 510 and document templates 512 stored in database(s) 508 are provided, for example, to generate customized documents 514. Rider information 510 may be uploaded from workstation 104, such as workstations 304/310, and then stored in database(s) 508. Custom documents 514 are available, such as for contracts, deal sheets, commission invoices, cover letters and disclosures, such as relating to lead paint.

Among other functionality and provided in at least one embodiment, information processor 102 enables a user manages to manage and/or edit information relating to a broker of a buyer or seller for a selected/processed deal. Information, such as a broker's business and address, is available for view and/or editing by a user. Additionally, a user can edit management company and/or title company information for a selected/processed deal. The company information and closing location preferably relates to residential properties, but may apply for other properties as well, including commercial properties. In case, for example, a property is self-managed, then the president, secretary, treasurer, other contact and/or transfer agent data is provided for viewing and or editing purposes. In one embodiment, editing is performed on a dedicated web page, such as where a user locates the management company to be edited by some identifier, such as a unique identifier assigned by information processor 102, the company's name or e-mail address, telephone number or the like.

Accordingly, information relating to a title company and/or a management company is available for viewing and/or editing. For example, information relating to the name of the company, the branch name of the company, the name of a contact person or the department of the company, the company address, the city for the company, the state name of the company, the postal code, telephone number(s) and e-mail addresses for the company are provide for viewing and/or editing. In addition, information relating to a building and/or property for a selected/processed deal is available. For example, the address, name, description and related information representing the property is available for viewing and/or editing.

Additionally, users of administrative options 500 can upload information relating to brokers/attorneys, management companies, title companies, and properties. Using these features, multiple entries can be prepared from otherwise disjointed parties in various formatted files, such as MS EXCEL, imported and parsed for use by information processor 102, thereby eliminating error-prone manual input and redundancy. In one embodiment, a user searches and/or locates an MS EXCEL data file and uploads the data into a database accessible by information processor 102. Additionally, users of administrative options 500 can save changes he/she made for new or current deals. The entered/changed data of the deal are to database(s) 508.

Riders 510 (FIG. 5) enable authenticated users of administrative options 500 to view, add and/or edit riders and/or addendums that may be applied during the course of a deal. For example, riders and/or addendums may be added, such as due to a post-condition to a deal. As noted above in connection with company-related data, information related to riders can be provided in variously formatted data files and imported or uploaded into database(s) 508 and accessed by information processor 102. In a preferred embodiment, existing riders/addendums for deal selected or entered by a user are displayed or otherwise provided by information processor 102. For example, names of riders and/or addendums are displayed and selectable by graphical screen controls, such as checkboxes, drop-down lists, bulleted lists or the like. In one embodiment, a user is presented with a graphical button to “browse” for riders/addendums and a file selection dialog display is displayed. The user optionally selects respective riders/addendums document and selects an option, such as labeled “OK” button to select the rider/addendum. The path of the chosen file is preferably displayed on the “Add” text box. In addition to adding and editing information related to deals, administrative options 500 also enable users to delete information related to property, brokers, buyers, sellers, deal points, legal points, management companies and contracts, as well as complete deals that may be canceled.

Accordingly, and in preferred embodiments, users make selections to set up deals, such by reviewing and selecting options from a list, as appropriate. As used herein, a selected deal for editing is referred to as “into activity” terms, and include, for example, unit details commission, parties, included items, real estate, legal points, closing information.

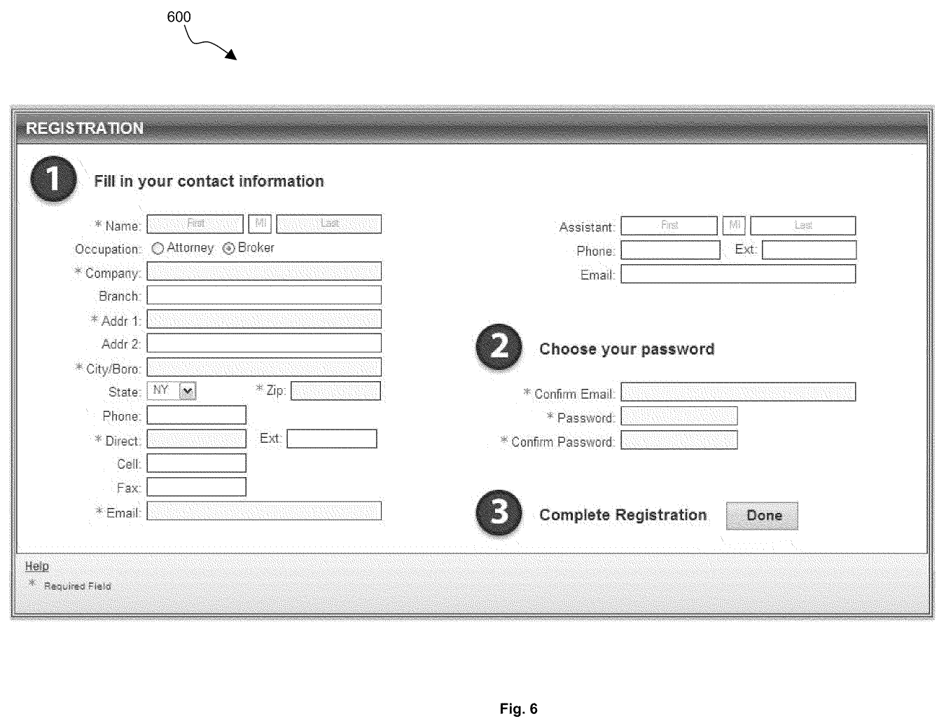

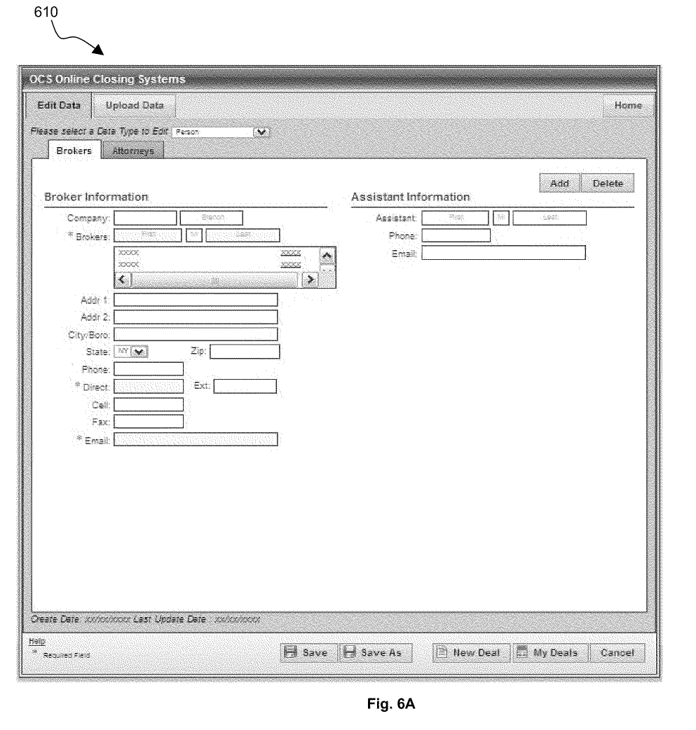

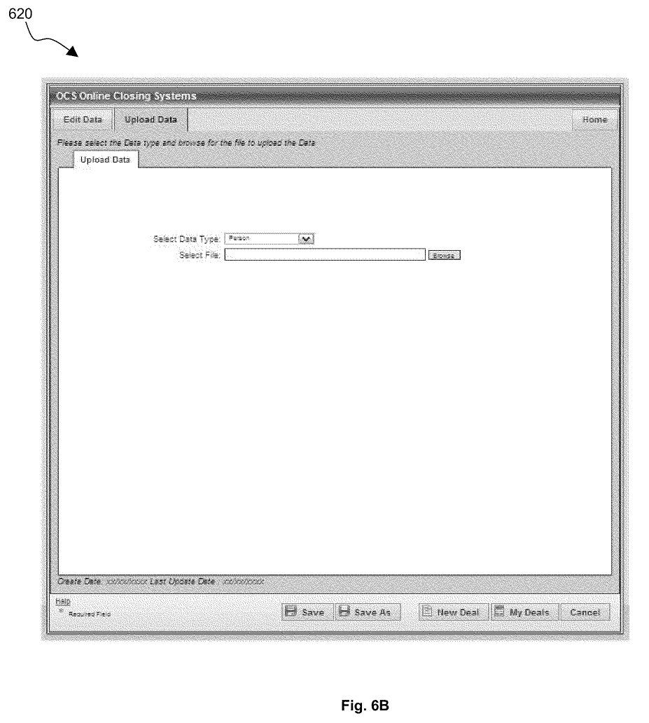

FIG. 6 illustrates an example display screen 600 for a user to register with information processor 102, for example, by entering identifying information, as well as authentication information to access information provided via information processor 102. For example and as shown in FIG. 6, a user enters contact information, including name, company, branch, address, e-mail, telephone information, assistant information or the like. Further, the user preferably identifies himself/herself as a broker or attorney, if appropriate. Additionally users submit authentication information via display screen 600, such as to define a user id (such as an e-mail address), password and/or a security question (not shown). This information is preferably stored in database 508 and referenced by information processor 102 when a user attempts to access information and/or display screens shown and described herein.

FIG. 6A illustrates an example display screen 610 that is useful for a broker user to add/edit information to information processor 102. For example, a broker user enters contact information, including name, company, branch, address, e-mail, telephone information, assistant information or the like. In addition to manually entering data,

FIG. 6B is an example display screen 620 for uploading data in accordance with an embodiment. As noted above, information can be uploaded relating to brokers/attorneys, management companies, title companies, properties and/or any of the kinds of data stored in database(s) 508 described herein.

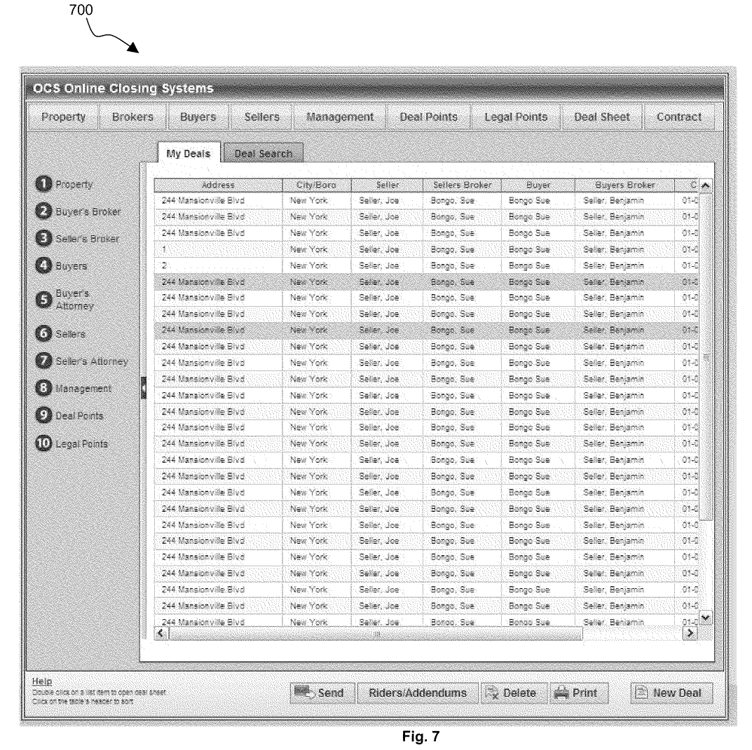

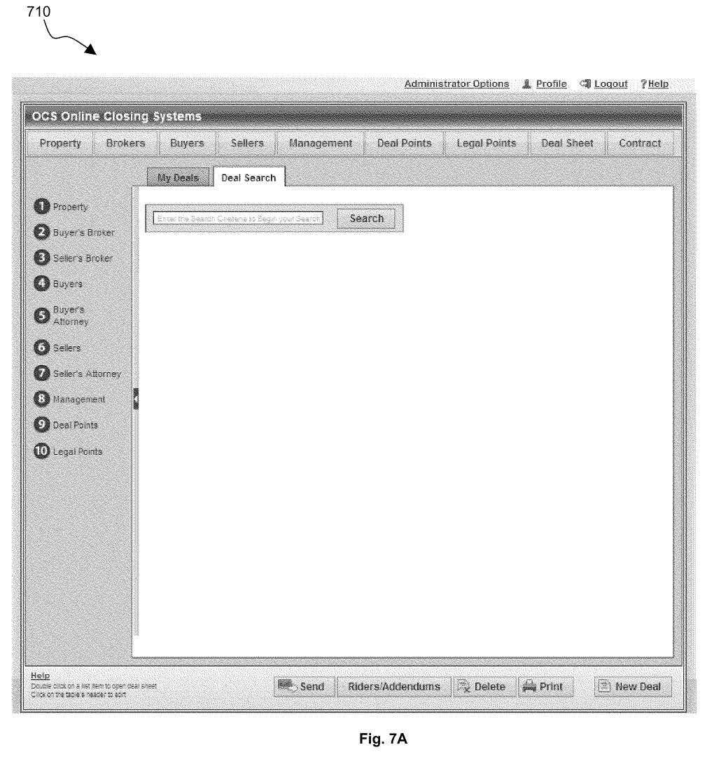

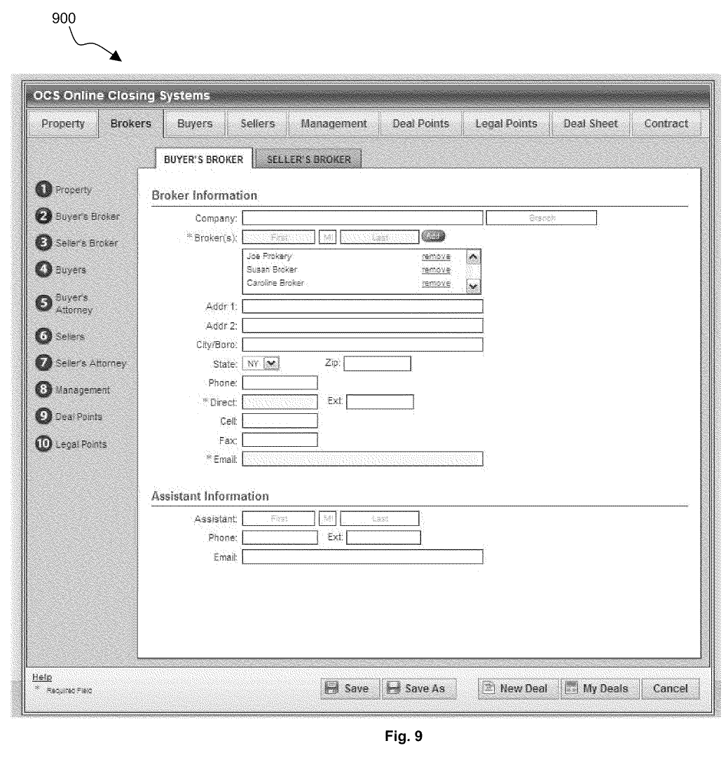

FIG. 7 illustrates an example display screen 700 for deals associated with a given user and formatted for selectable display in a table. In an embodiment, the user who has logged in to information processor 102, for example by submitting a user name and password, views his deals referred to herein as “My Deals” (not shown). The rows of information related to the deals are preferably selectable. Selection of a row enables details of a respective deal to be viewed, added, deleted and/or edited, such as in example display screens shown in FIGS. 9-16. In the example shown in FIG. 7, address information for a deal property, the name of the city or borough for the deal property, the names of the seller and buyer's brokers, a data creation date and data modified date are displayed. As noted above, data provided in connection with the table shown in FIG. 7 may be uploaded from, for example, one or more data files, such as a comma delimited text file, received from various parties.

FIG. 7A illustrates an example display screen 710 that is available for users to search for particular deals. Data entry fields are provided for a user to search for deals by entering one or more search criteria, including the property location, the name of the seller, buyer or respective broker, city, state, or zip code. Other criteria may also be used, such as telephone and/or email address (not shown). Additionally, information may be provided (in the form of a bulleted list in example display screen 710) for the type of property, including a condominium, cooperative, combination condominium and cooperative, townhouse and/or single family dwelling. Once entered, information for corresponding deals is preferably provided in a selectable display, such as illustrated in FIG. 7. Although users typically search only for the deals that they are involved in, administrative users may be authorized to search for information related to any deals that are accessible by information processor 102.

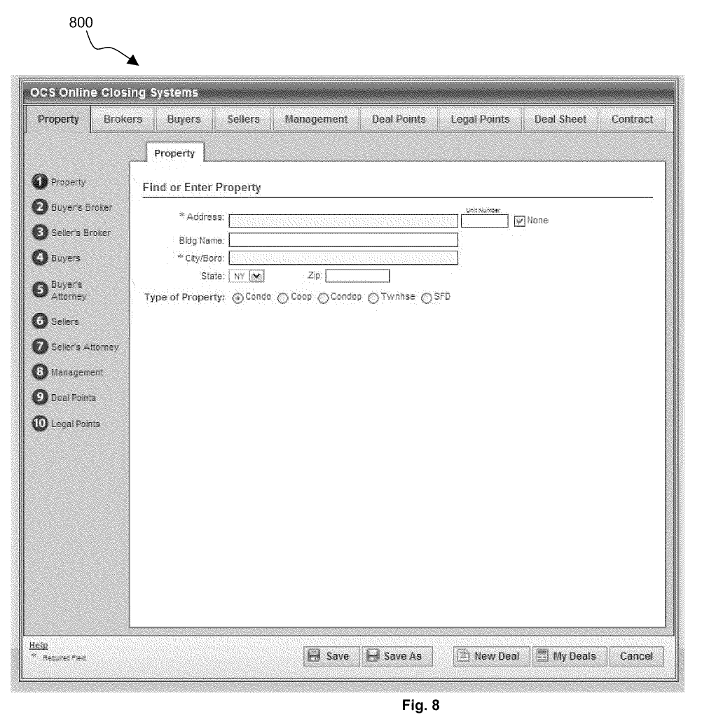

FIG. 8 is an example display screen 800 for locating or editing information regarding a property, in accordance with an embodiment. Users enter address, building name, city, state zip and type of property information in display screen 800.

FIGS. 9-16 illustrate example display data entry screens that are provided for users of online closing system 100 in connection with various deals.

FIG. 9 shows an example data entry data screen 900 for users to add/edit information related to buyers' and sellers' brokers, in accordance with an embodiment. For example and as shown in FIG. 9, a buyer's broker information, including name and contact information, assistant information is displayed, entered and/or edited via data entry display screen 900. Similarly, a seller's broker information, including name and contact information, assistant information is displayed, entered and/or edited via data entry display screen 900. Graphical screen controls are further provided at the bottom of FIG. 9, such as for viewing/editing rider information, as well as to save, print and/or transmit data related to a deal. Deal sheets are further listed via the graphical screen controls, as a control to add a new deal.

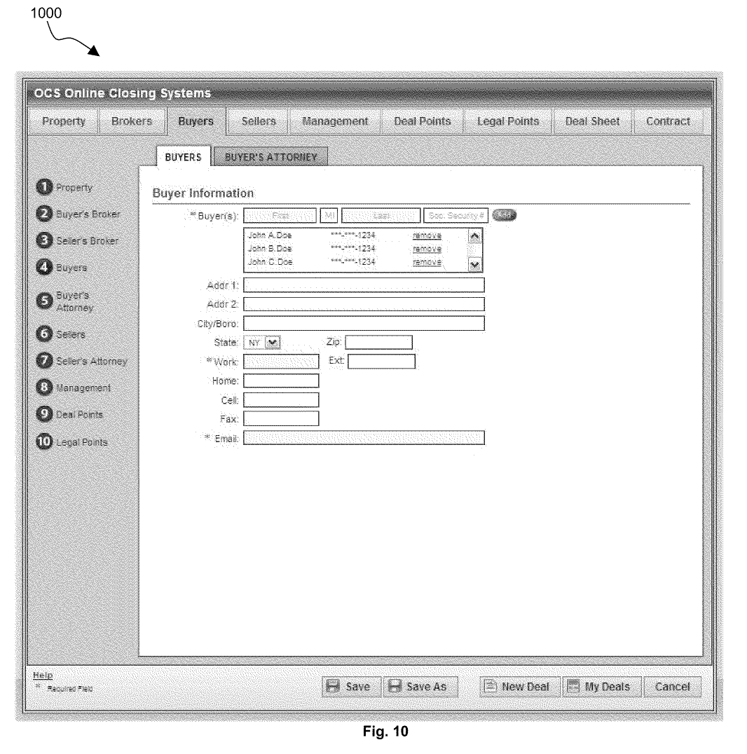

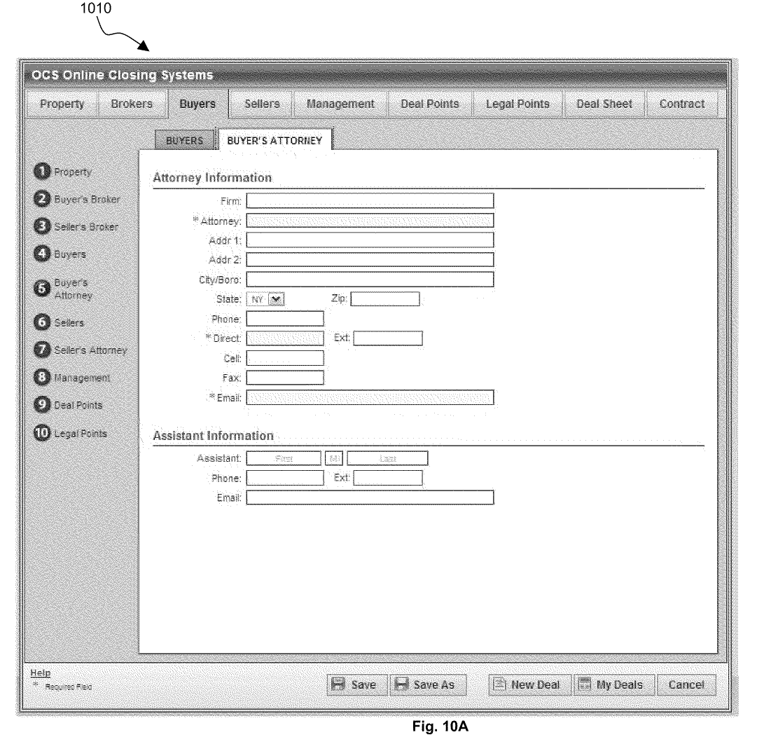

FIG. 10 shows an example data entry data screen 1000 for users to add/edit information related to buyers of properties, in accordance with an embodiment. For example and as shown in FIG. 10, a buyer's information, including name and contact information is displayed, entered and/or edited via data entry display screen 1000. Additionally, a buyer's attorney information, including name and contact information, assistant information is displayed, entered and/or edited via data entry display screen 1000. Graphical screen controls are further provided at the bottom of FIG. 10, such as for viewing/editing rider information, as well as to save, print and/or transmit data related to a deal. Deal sheets are further listed via the graphical screen controls, as a control to add a new deal.

FIG. 10A shows an example data entry data screen 1010 for users to add/edit information related to buyers' attorneys, in accordance with an embodiment.

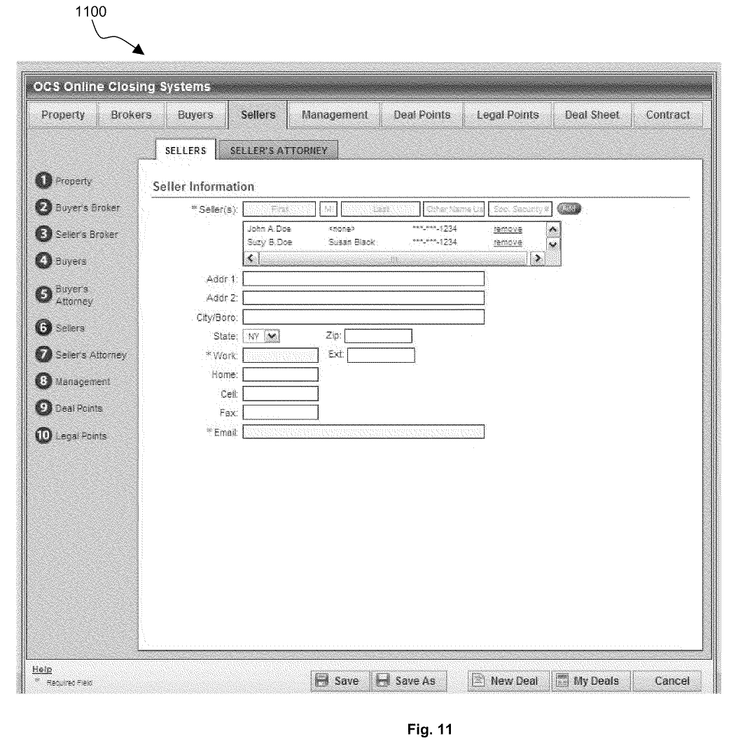

FIG. 11 shows an example data entry data screen 1100 for users to add/edit information related to sellers of properties, in accordance with an embodiment. For example and as shown in FIG. 11, a seller's information, including name and contact information is displayed, entered and/or edited via data entry display screen 1100. Additionally, a seller's attorney information, including name and contact information, assistant information is displayed, entered and/or edited via data entry display screen 1100. Graphical screen controls are further provided at the bottom of FIG. 11, such as for viewing/editing rider information, as well as to save, print and/or transmit data related to a deal. Deal sheets are further listed via the graphical screen controls, as a control to add a new deal.

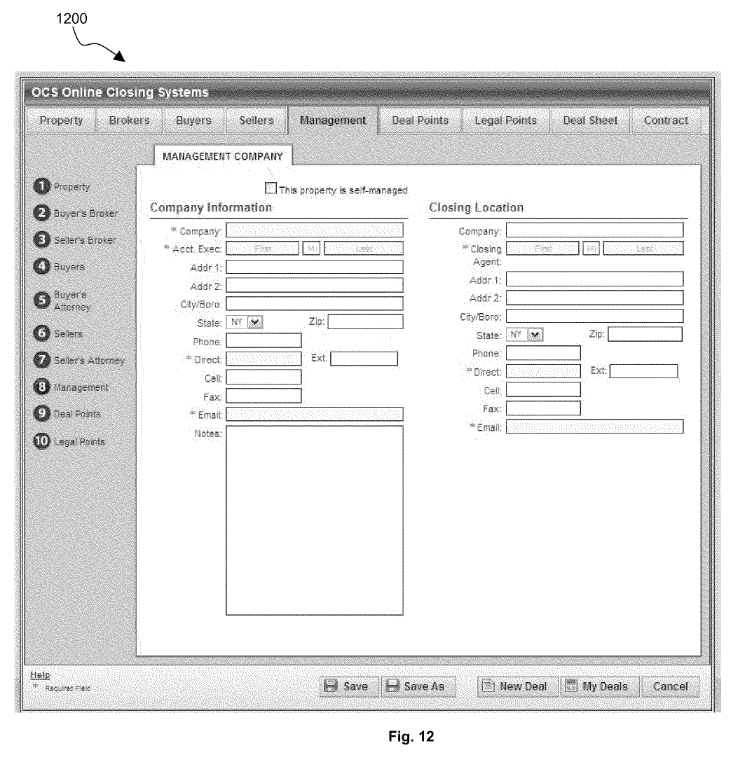

FIG. 12 shows an example data entry data screen 1200 for users to add/edit information related to management companies and/or closing companies, in accordance with an embodiment. For example and as shown in FIG. 12, a management company's information, including name and contact information is displayed, entered and/or edited via data entry display screen 1200. Additionally, a closing company's information, including name, agent and contact information, assistant information is displayed, entered and/or edited via data entry display screen 1200. Graphical screen controls are further provided at the bottom of FIG. 12, such as for viewing/editing rider information, as well as to save, print and/or transmit data related to a deal. Deal sheets are further listed via the graphical screen controls, as a control to add a new deal.

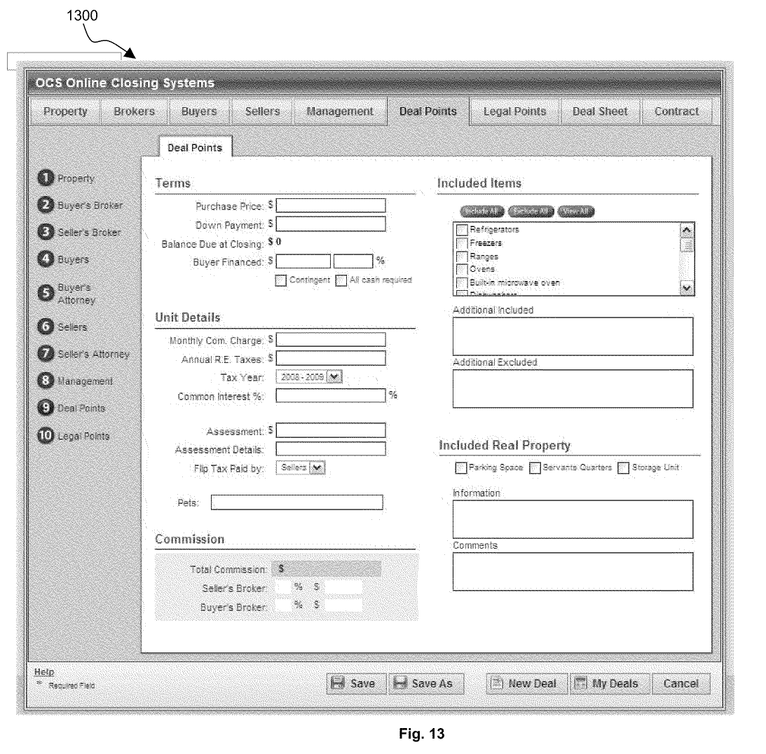

FIG. 13 shows an example data entry data screen 1300 for users to add/edit information related to deal points in connection with a particular deal. For example and as shown in FIG. 13, information related to one or more of a property purchase price, down payment amount, balance due at closing, whether pets are allowed and, if so, how many, buyer's financial information, inclusions, maintenance amounts, percentages of shared transferred, assessment amount, partying paying a “flip” tax (as known in the art), total commission and commission percentages and amounts per respective broker, and any other additional inclusions, such as parking, separate quarters, storage units and/or any other information entered in data entry text fields is provided in the example display screen 1300 shown in FIG. 13. Graphical screen controls are further provided at the bottom of FIG. 13, such as for viewing/editing rider information, as well as to save, print and/or transmit data related to a deal. Deal sheets are further listed via the graphical screen controls, as a control to add a new deal.

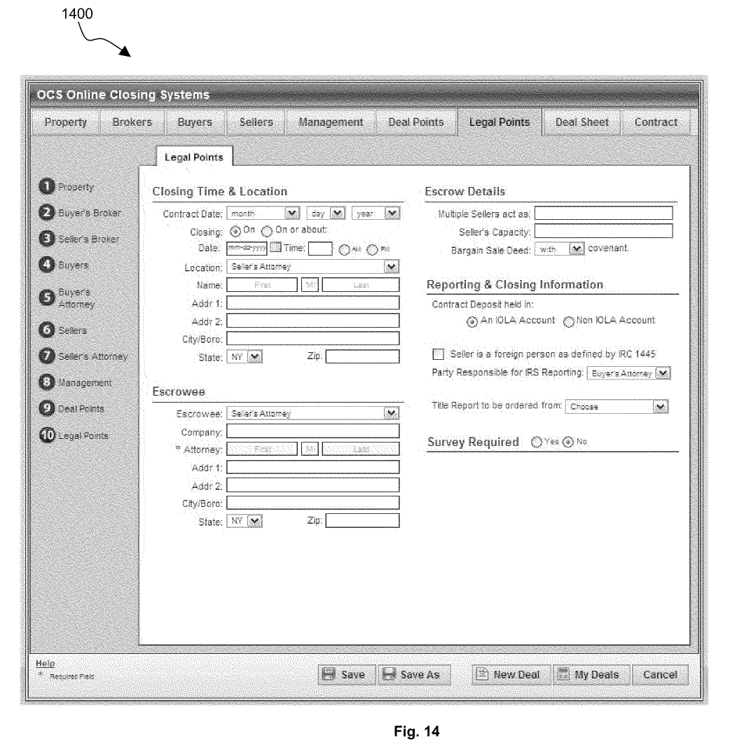

FIG. 14 shows an example data entry data screen 1400 for users to add/edit information related to legal points in connection with a particular deal. For example and as shown in FIG. 14, information related to one or more of a contract date, closing information, location and contact information for the party where the closing takes place, and respective seller information is preferably provided in the example display screen 1400 shown in FIG. 14. Moreover and as shown in FIG. 14, escrow details information is displayed, edited and/or added via display screen 1400. For example, information relating to attorneys, escrow dates, contract information, deposit holding information, Internal Revenue Service reporting responsible party, survey information, and revenue information is preferably provided in the example display screen 1400 shown in FIG. 14. Graphical screen controls are further provided at the bottom of FIG. 14, such as for viewing/editing rider information, as well as to save, print and/or transmit data related to a deal. Deal sheets are further listed via the graphical screen controls, as a control to add a new deal.

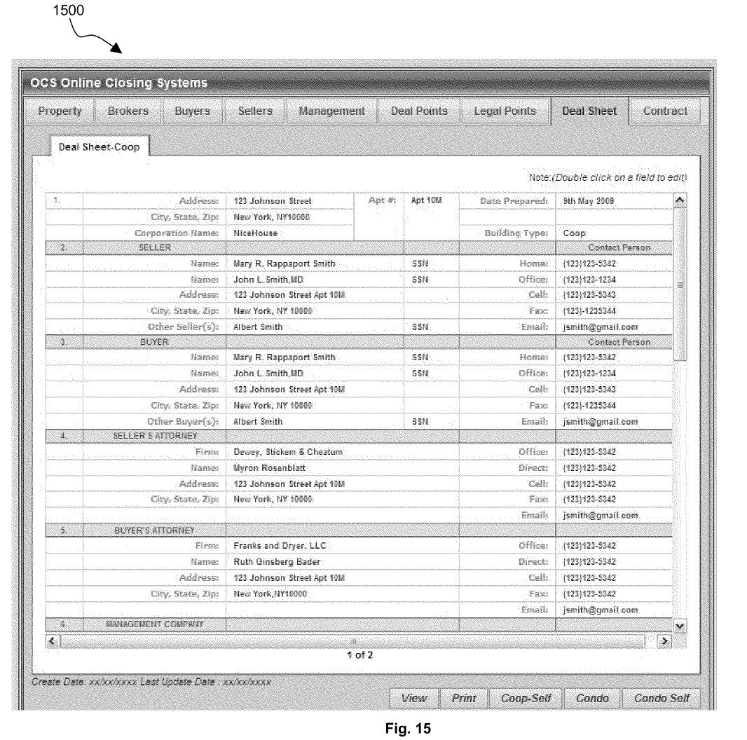

FIG. 15 shows an example data entry data screen 1500 for users to add/edit information related to a deal sheet in connection with a particular deal. Preferably, information provided via data entry screens, such as related to the property, seller, buyer, attorneys, brokers, management information, and the like, are displayed in data entry screen 1500. In the example shown in FIG. 15, the data are formatted as hyperlinks such that any selection of a data item launches the corresponding data entry display screen for that data for additional editing. For example, by double clicking the seller name, Mary R Rapport Smith (FIG. 15), data entry display screen 1100 will be provided and information related to Mary R Rapport Smith will be displayed therein.

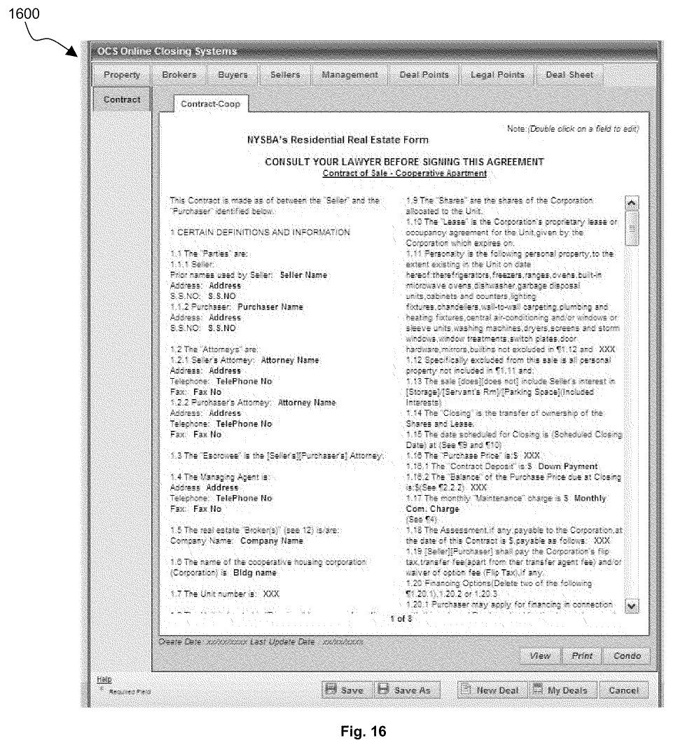

FIG. 16 illustrates an example data display screen 1600 for a contract in accordance with an embodiment. The contract shown in screen 1600 is preferably editable, such as by selecting (double-clicking) a particular provision. As shown in FIG. 16, the contract is also preferably scrollable for viewing multiple pages.

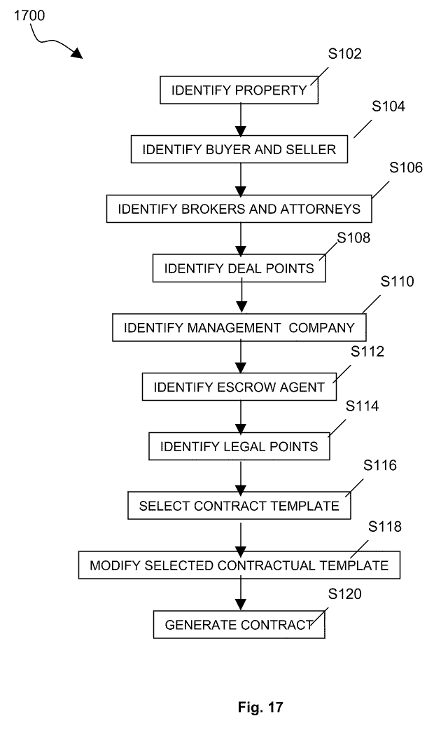

FIG. 17 is a flowchart showing example steps associated with providing a contract in accordance with information processor 102, such as by selecting an option for “contract” from options 506. As shown in the flowchart in FIG. 15, a user identifies or selects a property for a deal, such as described above in connection with display screen 800 (step S102). Additionally, a buyer and seller of the selected property are identified and/or selected from information stored in database(s) 508 (step S104). At step S106, the buyer's and seller's brokers and attorneys are selected and/or identified via information stored in database(s) 508. In addition to parties and their respective agents to a deal, deal points are identified and/or selected from information stored in database(s) 508 (step S108). Moreover, a management company is identified and/or selected in step S110 from information stored in database(s) 508, and escrow agent is identified and/or selected at step S112. In addition, deal points for the deal are selected in step S114. Thereafter, a contract template is preferably selected from database(s) 508 (step S116). In one embodiment, database(s) 508 stores a plurality of contract templates for various property types, such as single family dwellings, cooperatives, condominiums, or the like. In an alternative embodiment, particular contract templates are selected for particular attorneys, who have previously identified respective contract templates that are preferred. The contract templates are modifiable, and usable to provide completed, enforceable contracts that are provided to the parties of a real estate purchase and sale during various stages of a deal, including at the closing. At step S118, the contract template is modified with the information selected in steps S104-S114, as well as with any other suitable information provided by a user accessing display screens provided via information processor 102. Thereafter, the contract is generated (step S120) and is available for review, further modification and/or execution. Thus, using the systems and methods described herein and via one or more of the steps illustrated in FIG. 17, contracts are generated and useable for real estate transactions.

In one embodiment, administrators are authorized to disable or otherwise delete a deal. Preferably, deleted or disabled deal data are not removed from database 508, but merely marked as removed. Further, administrator users may be entitled to define various other respective user rights, such as to receive the invitation from other users to the deal, to receive notification of new deal sheets, to receive notification of a new cover letter, to receive notification of new cover letter, to receive notification of new contracts, to receive notification of new riders/addendums, to receive notification of new lead paint disclosures, to receive notification of a new commissions invoice, to receive notification of new request for lien search, or the like. Alternatively, more restrictive uses can be defined, such as to limit a user's access to receive just company name data from the sender.

As noted above and in an embodiment, registered users view deal information via display screens and over the Internet. Electronic files, such as for deal sheets, cover letters, contracts, riders, disclosures (such as related to lead paint) or the like may be attached, such as to e-mail messages and are then available via information processor 102. Other documents, such as commission invoices, requests for lien searches, may also be provided via e-mail attachments. Alternatively, documents may be uploaded via FTP or other known and suitable technique.

In an embodiment, rules are provided for notifying parties associated with the teachings herein, such as for a buyer, a buyer's broker, a buyer's attorney, a seller, a seller's broker, a seller's attorney, a management company, a closing company, a closing attorney, a bank attorney or other user. One form of notification may occur via e-mail, although other suitable notification formats may be employed. Preferably, e-mail addresses for brokers, attorneys and/or other parties are checked for accuracy. In another embodiment, e-mail is manually transmitted via an option to “Notify Other Users by E-mail” web page. This preferably enables a new broker or attorney user to receive an invitation via e-mail that includes a link to registration display screen 600, and the new user registers his/her profile accordingly.

Accordingly, it is an object of the teachings herein to provide real estate brokers, transactional attorneys, and other parties associated with real estate transactions with an interactive and accessible tool for accurate and efficient purchases and sales of real estate between buyers and sellers. Users are able to display, browse, upload, remove, various forms of information, including related to real estate purchase contracts, property types, deal sheets, brokers and attorneys, thereby ensuring consistent and efficient communication and information dissemination, and eliminating multiple re-typing of same data by buyer/seller real estate brokers and buyer/seller attorneys when preparing contract, deal sheet, and so on documents by making the online system for all the involved parties. By providing the systems and methods disclosed herein, the number of hours required for daily operations and corresponding maintenance costs are significantly reduced over typical, prior art real estate transactions, at least in part as a function of electronic interaction and data provided to a plurality of parties via information processor 102.

Although the present invention has been described in relation to particular embodiments thereof, many other variations and modifications and other uses will become apparent to those skilled in the art. For example, although many of the examples provided herein relate to real estate transactions, the invention is not so limited. Any contractual arrangement can be supported by the teachings, as can any transaction involving a plurality of otherwise disparate parties. Moreover, other functionality such as a detailed library of forms and an automatic creation of each document required for a real estate transaction closing is provided in alternative embodiments. Moreover, a crawler, as known in the art, is provided in an embodiment and available for searching for information related to real estate transactions. Information that is stored on an Internet web site, such as related to a management company, can be located and retrieved by a crawler and stored database(s) 508. Further, as such information is updated or changes, the crawler can automatically provide the changes and update the database(s) 508.

Moreover, useful information is collected, stored and potentially made available for, for example, brokers, appraisers or lenders when assessing the marketplace or valuing a particular property. Information relating to sales price, dates of sales, parties or the like can be organized for statistical analysis. Since information is collected and stored in database(s) 508 that is not otherwise available in the prior art as set forth in accordance with the teachings herein, various parties are particularly interested in obtaining such statistical information. Without the systems and methods provided herein, data are not provided in as a timely fashion, or in as inclusive, convenient or accurate way.

In another embodiment, one or more modules are provided to receive lender-provided information, such as documents, that preferably contain data that are used to populate closing documents, including a HUD-1 document, as provided by Federal Regulations. In this embodiment, the lender-provided information, along with deal point information, legal point information and other information as appropriate, serve to complete the HUD-1 document. Moreover, a buyer and seller are able to review their respective documents together with or independent of their attorneys and brokers, for understanding and correctness. Additionally, the information may automatically, upon command, generate disbursement information for all parties who have a financial interest in the proceeds of the transaction, including but not necessary limited to principals, vendors, agents or attorneys. Furthermore, checks are provided or fund disbursements are provided, such as via wire transfer or other appropriate method.

It is preferred, therefore, that the present invention not be limited by the specific disclosure herein.

What is claimed is:

1. A method for processor-enabled interactive real estate deals, the system comprising:
storing, on one or more processor readable media that are operatively coupled to one or more processors, at least one database comprising:
electronic deal information including information representing at least one real estate transaction;
electronic buyer information including information representing at least one buyer respectively associated with the at least one real estate transaction;
electronic seller information including information representing at least one seller respectively associated with the at least one real estate transaction;
electronic broker information including information representing at least one of a buyer broker and a seller broker respectively associated with the at least one buyer and the at least one seller;
electronic deal point information including information representing at least deal point associated with the at least one real estate transaction;
electronic management company information including information representing at least one management company respectively associated with the at least one real estate transaction;
electronic deal point information including information representing at least one deal point respectively associated with the at least one real estate transaction; and
electronic contract template information representing at least one contract respectively associated with the at least one real estate transaction;
providing at least one contract as a function of at least one selection of at least one of the electronic deal information, the electronic buyer information, the electronic seller information, the electronic broker information, the electronic broker information, the electronic deal point information, the electronic management company information, the electronic deal point information and the electronic contract template information for a respective one of the at least one real estate transaction.

2. The method of claim 1, further comprising receiving by the one or more processors from a computing device at least one of the electronic deal information electronic buyer information, electronic seller information, electronic broker information, electronic deal point information, electronic management company information, electronic deal point information, electronic contract template information, electronic deal information, electronic buyer information, electronic seller information, electronic broker information, electronic deal point information, electronic management company information, electronic deal point information and the electronic contract template information, respectively.

3. The method of claim 2, wherein the at least one of the respective electronic information is formatted as at least one electronic data file.

4. The method of claim 3, further comprising extracting by the one or more processors data from the electronic data file and storing the data in the at least one database.

5. The method of claim 4, further comprising providing by the one or more processors an Internet web site, wherein the at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information, the electronic deal point information and the electronic contract template information is respectively displayed in the Internet web site.

6. The method of claim 5, further comprising configuring by the one or more processors the at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information, the electronic deal point information and the electronic contract template information in a format for a user to be modified by computing devices accessing the Internet web site.

7. The method of claim 5, further comprising providing to a computing device accessing the Internet web site the at least one of the electronic deal information electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information and the electronic deal point information upon receiving a selection of a term in the electronic contract template information.

8. A system for processor-enabled interactive real estate deals, the system comprising:
one or more processor readable media that are operatively coupled to one or more processors;
at least one database stored on the processor-readable media comprising:
electronic deal information including information representing at least one real estate transaction;
electronic buyer information including information representing at least one buyer respectively associated with the at least one real estate transaction;
electronic seller information including information representing at least one seller respectively associated with the at least one real estate transaction;
electronic broker information including information representing at least one of a buyer broker and a seller broker respectively associated with the at least one buyer and the at least one seller;
electronic deal point information including information representing at least deal point associated with the at least one real estate transaction;
electronic management company information including information representing at least one management company respectively associated with the at least one real estate transaction;
electronic deal point information including information representing at least one deal point respectively associated with the at least one real estate transaction; and
electronic contract template information representing at least one contract respectively associated with the at least one real estate transaction; and
at least one contract provided as a function of at least one selection of at least one of the electronic deal information, the electronic buyer information, the electronic seller information, the electronic broker information, the electronic broker information, the electronic deal point information, the electronic management company information, the electronic deal point information and the electronic contract template information for a respective one of the at least one real estate transaction.

9. The system of claim 8, wherein at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information, the electronic deal point information and the electronic contract template information, respectively, is received by the one or more processors from a computing device.

10. The system of claim 9, wherein the at least one of the respective electronic information is formatted as at least one electronic data file.

11. The system of claim 10, wherein the one or more processors extract data from the electronic data file and store the data in the at least one database.

12. The system of claim 11, further comprising an Internet web site provided by the one or more processors, wherein the at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information, the electronic deal point information and the electronic contract template information is respectively displayed in the Internet web site.

13. The system of claim 12, wherein the at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information, the electronic deal point information and the electronic contract template information is configured by the one or more processors in a format for a user to be modified by computing devices accessing the Internet web site.

14. The system of claim 12, wherein the at least one of the electronic deal information, the electronic buyer information, the electronic seller information, the electronic broker information, the electronic deal point information, the electronic management company information, the electronic deal point information, the electronic contract template information, the electronic deal information, the electronic buyer information, the electronic seller information, the electronic broker information, the electronic deal point information, the electronic management company information and the electronic deal point information is provided to a computing device accessing the Internet web site upon receiving a selection of a term in the electronic contract template information.
